(19) United States
(12) Patent Application Publication
(10) Pub. No.: US 2012/0109697 A1
(43) Pub. Date: May 3, 2012

(54) ASSESSING HEALTH OF PROJECTS

(76) Inventors: Marianne Hickey, Bristol (GB); Andrew Byde, Cardiff (GB); Maher Rahmouni, Bristol (GB); Claudio Bartolini, Palo Alto, CA (US)

(21) Appl. No.: 12/916,043

(22) Filed: Oct. 29, 2010

(51) Int. Cl. G06Q 10/00; G06Q 90/00

(52) U.S. Cl. 705/7.11; 705/500

(57) ABSTRACT

Determining vectors for a set of project features and determining an indication of health of some aspect of the project using a classifier trained for the set of project features is useful in assessing project health. Classifiers can be trained for such methods by determining a set of training elements for one or more projects of a data set, and training the classifier using the set of training elements. Each training element comprises a feature vector for a particular project at a particular time interval and a health classification deemed to be correct for that particular project at that particular time interval.

### BACKGROUND

Large organizations frequently have a multitude of projects ongoing at any one time. Project and portfolio management (PPM) tools have been developed to help these organizations in managing resources, e.g., time, people, money, equipment, etc., for their various projects. HP PPM Portfolio Management, available from Hewlett-Packard Company, Palo Alto, Calif., USA, is one example of a PPM tool.

Oftentimes, PPM tools offer the ability to enter an indication of project health, or to calculate an indication of project health using business rules, for each project. However, manually entering an indication of project health, or calculating an indication of project health using business rules, each suffer limitations in assessing project health.

For the reasons stated above, and for other reasons that will become apparent to those skilled in the art upon reading and understanding the present specification, there is a need in the art for alternative methods and apparatus for assessing health of projects.

### BRIEF DESCRIPTION OF THE DRAWINGS

FIG. 1 is a representation of a computer system for use with various embodiments of the disclosure.

FIG. 2 depicts the hierarchy in the use of multiple classifiers in accordance with an embodiment of the disclosure.

FIG. 3 depicts a flowchart of training of a classifier for use with embodiments of the disclosure.

FIG. 4 depicts a flowchart of use of a classifier in accordance with embodiments of the disclosure.

FIG. 5 depicts a flowchart of use of more than one classifier in accordance with embodiments of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process or mechanical changes may be made without departing from the scope of the present disclosure. The following detailed description is, therefore, not to be taken in a limiting sense.

Projects that are delivered late, run over budget and/or fail to meet customer or client expectations can have significant monetary and reputation costs. Potential delivery failure is often undetected by, or hidden from, management. Furthermore, projects can move from healthy to critical rapidly and without notice. Consequently, escalations may not occur until projects reach a critical state. Without advanced warning of critical situations, leadership may be unable to be proactive and take mitigating or preventative actions to reduce the number of critical situations or their severity.

Project and Portfolio Management (PPM) tools allow management to view the health of projects. For example, the health of a project may be represented via red/amber/green color indicators, where green may represent a healthy project, amber may represent a project in trouble, and red may represent a project in a critical state. Other indicators may also be used, such as a scale of 1 to 10 or the like representing various levels of health. Indicators may also be used to represent different aspects of project health. In addition to an indicator representing overall project health, there may also be indicators for issue health, schedule health, cost health or health of some other project portion. Project health typically may be entered manually or it may be calculated using business rules.

With the manual process of assessing project health, the health status may be updated after review of the project, typically by the project manager. This approach has several limitations. For example, such manual processes may not provide early prediction of delivery failure for the project. Human error may also affect the assessment, e.g., a project manager, especially an inexperienced one, might not notice that there is a problem at the time of assessment. Such manual assessments are also subjective and may be inconsistent between different assessors. Similarly, it may be difficult to do a finer-grained assessment of a project's health manually, i.e., with more granularity than a red, amber or green health status, given a project's complexity. In addition, while the minutiae of the project data may indicate trouble, such interpretation of the minutiae may not be apparent to, or feasible for, a project manager. The frequency of assessing the health of projects may be random and sporadic if performed manually. And manual assessment takes up management time and, therefore, may incur significant monetary cost.

With the business rule process of assessing project health, business rules, often manually entered, examine and combine the values of a variety of project metrics, such as the number of issues raised, milestones missed or the ratio between actual and planned costs or effort hours. This approach also has limitations. For example, it may require expert knowledge to create the rules and maintain them, which can be time consuming and costly. It may be difficult, if not impracticable, to go through and analyze thousands of projects in order to construct accurate rules. And while default rules can be provided by the PPM tool, or even by a central project management office, these may not be the best fit for a particular organization, or a particular department or subdivision of an organization. In rapidly changing business environments and technology, these rules can become outdated, making them inaccurate in assessing project health. And while some PPM tools provide the ability to utilize business rules to assess project health, in practice, the facility to apply business rules in PPM tools is not always used, with project and portfolio management often resorting to manually entering project health in lieu of developing adequate rules.

Various embodiments described herein include methods of assessing health of projects using classifiers. Machine learning research has led to classifiers, such as statistical linear classifiers, capable of making a classification decision on the basis of a set of observed examples, i.e., training data. Statistical linear classifiers do this by determining the value of a linear combination of features of interest in relation to the training data. Examples of statistical linear classifiers might include spam filters. Other examples of classifiers include quadratic classifiers, kernel estimation classifiers, Bayesian network classifiers, k-nearest neighbor (kNN) classifiers, etc. Classifiers are well understood in the art and the embodiments are not limited to a specific classifier.

In general, for various embodiments, classifiers are trained with historical data, i.e., the training data, taken over a number of time intervals, for a number of projects. A health score is assigned to each project at each time interval. The time intervals may be periodic, e.g., daily or weekly, or they may be variable, e.g., taken at project milestones or other non-periodic basis. In addition, the time intervals may be the same for all projects of the training data, or one or more projects of the training data may use different time intervals than one or more other projects of the training data.

The health score of each given project at each given time interval is deemed to be correct. For example, the health scores can be manually verified or calculated using business rules. Because the classifiers are trained with historical data, the health scores can take into account the ultimate success or failure of the project. For example, although a business rule calculation, or a manual verification made without the advantage of hindsight, may determine the project health to have a particular value at a particular time interval, that particular value might be adjusted up or down based on the ultimate level of success or failure, respectively, of that project at its final time interval.

The training data may be randomly selected over a broad range of projects. Alternatively, the training data may be tailored to one or more specific types of projects. Thus, a classifier could be trained for a specific industry, department, technology, etc., rather than generic projects. A classifier could be pre-trained with data not necessarily of an organization intending to use the classifier. Because classifiers continue to learn through additional data, even pre-trained classifiers will tend to adapt themselves to the environment in which they are used. Thus, while two different entities may start out with the same pre-trained classifier, the classifier for each entity will tend to become more accurate at classifying that entity's projects as that entity enters additional data into the classifier.

In various embodiments, a project (or portions of a project, or a portfolio of projects) is viewed as a set of “features” that describe it and, optionally, its history. These features can represent the kind of data that may be collected in a PPM system, or the kinds of attributes that may be included in their business rules. However, project features are not limited to either of these and can include any attribute of a project that can be either quantified or classified.

Some features may not change over the project's lifetime (e.g. project type, name, start date, etc.), while others may (e.g., the amount of time spent working on each item so far, the number of issues raised, departments involved, etc.). A feature can also be a relationship between other features. For example, planned values such as cost, effort or staffing can be compared to actual values, and the discrepancy used as a feature. A feature can further be a delta between some feature at the current time and that feature at a previous time. Furthermore, a feature can be a vector representing values of a project metric or attribute over time.

For various embodiments, a classifier is initially trained using data that includes, for each project, and for a number of time intervals, the set of features and the correct (i.e., deemed to be correct) classification of the metric or indicator of interest, for example, a health indicator. The classifications in the training data may, for example, have been produced manually, or using existing business rules, or by some other means.

For a project in progress, the classifier may take project features and map them directly to the desired metric or indicator, e.g., project health. The classification may be a category, such as red or amber or green for a health indicator, or it may be finer grained, up to and including the point where it is possible to rank all projects according to their classification from healthiest to least healthy. The classification may also represent a prediction of the desired metric for a future time period.

Automatic re-classification can be triggered by various events, for example, time or a change in the value of one or more project features. Such trigger events can be configured by a system administrator or other user. For some embodiments, the metric classification produced by the trained classifier can be manually overridden. The classifier can be configured to re-train upon trigger events including such updated, manually-confirmed data.

Some embodiments allow for configuration of which metrics will be calculated and tracked for a given project, or group of projects. Examples are health metrics such as overall project health, issue health, schedule health, cost health, or other metrics.

One or more classifiers may be utilized in a PPM system, and each may be trained on its own particular set of features. The classifiers may, optionally, be arranged in layers. For example, an overall project health classifier may have as input features the output from a schedule health classifier, an issue health classifier and a cost health classifier. Similarly, a portfolio health classifier, concerned with a portfolio of one or more projects, may have as input the output from the overall project health classifier.

In general, features may be selected to have some relationship to whether a project is considered successful or not, e.g., difference between planned and actual cost or time, number of milestones met, type of project, size of project, departmental or geographic spread of participants, etc. However, embodiments described herein permit the use of virtually any definable feature to train a classifier. A trained classifier would often be able to indicate which features have little or no statistical correlation to the desired metric, and those features could then be removed from consideration. Examples of additional features include whether a project is behind schedule, e.g., when completed work (earned hours) is less than scheduled work (planned hours); whether a project is over accomplished hours, e.g., when actual hours exceed completed work (earned hours); whether a project is over budget, e.g., when actual cost exceeds completed cost (earned value); and whether a project is over budget billable, e.g., when billable cost exceeds the completed cost billable (earned value billable).

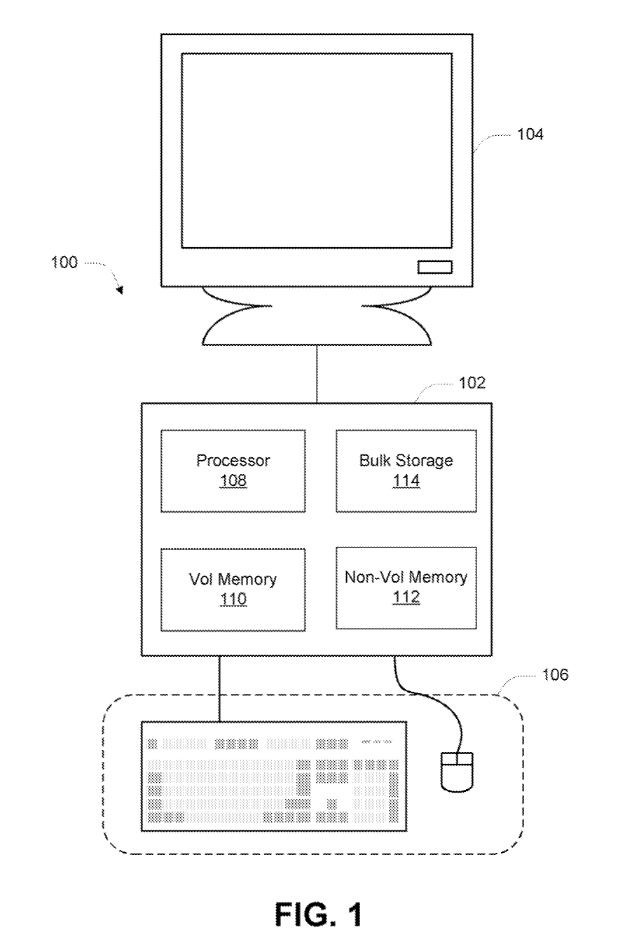

FIG. 1 shows an exemplary computer system 100 suitable for use with various embodiments of the disclosure. The computer system 100 includes a computing device 102, one or more output devices 104 and one or more user input devices 106.

The computing device 102 may represent a variety of computing devices, such as a network server, a personal computer or the like. The computing device 102 may further take a variety of forms, such as a desktop device, a blade device, a portable device or the like. Although depicted as a display, the output devices 104 may represent a variety of devices for providing audio and/or visual feedback to a user, such as a graphics display, a text display, a touch screen, a speaker or headset, a printer or the like. Although depicted as a keyboard and mouse, the user input devices 106 may represent a variety of devices for providing input to the computing device 102 from a user, such as a keyboard, a pointing device, selectable controls on a user control panel, or the like.

Computing device 102 typically includes one or more processors 108 that process various instructions to control the operation of computing device 102 and communicate with other electronic and computing devices. Computing device 102 may be implemented with one or more memory components, examples of which include a volatile memory 110, such as random access memory (RAM), dynamic RAM (DRAM), synchronous DRAM (SDRAM) and the like; non-volatile memory 112, such as read-only memory (ROM), flash memory or the like; and/or a bulk storage device 114. Common examples of bulk storage devices include any type of magnetic, optical or solid-state storage device, such as a hard disc drive, a solid-state drive, a magnetic tape, a recordable/rewriteable optical disc, and the like. The one or more memory components may be fixed to the computing device 102 or removable.

The one or more memory components are computer-usable media to provide data storage mechanisms to store various information and/or data for and during operation of the computing device 102, and to store computer-readable instructions adapted to cause the processor 108 to perform some function. One or more of the memory components contain computer-readable instructions adapted to cause the processor 108 to perform methods in accordance with embodiments of the disclosure. One or more of the memory components contain a data set for use with embodiments of the disclosure. As used herein, a computer-usable medium is a tangible, non-transitory medium in which data may be stored, and from which stored data may be later retrieved. Although the computing device 102 is depicted to be a single entity in FIG. 1, the components, i.e., the processor 108, the volatile memory 110, the non-volatile memory 112, and the bulk storage device 114, may be distributed, such as throughout a network. Similarly, there may be more than one processor 108, volatile memory 110, non-volatile memory 112 and/or bulk storage device 114. Thus, the instructions and the data set need not be contained within the same memory component, and they need not be contained within the same computing device 102 provided that they are networked for communication between the various components.

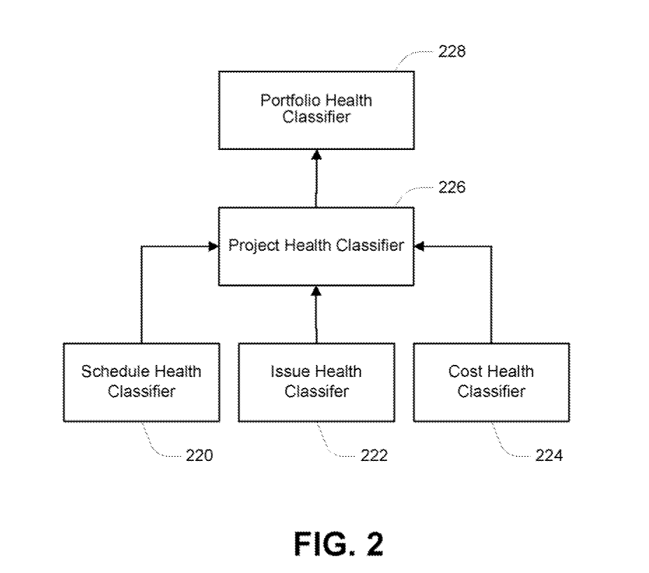

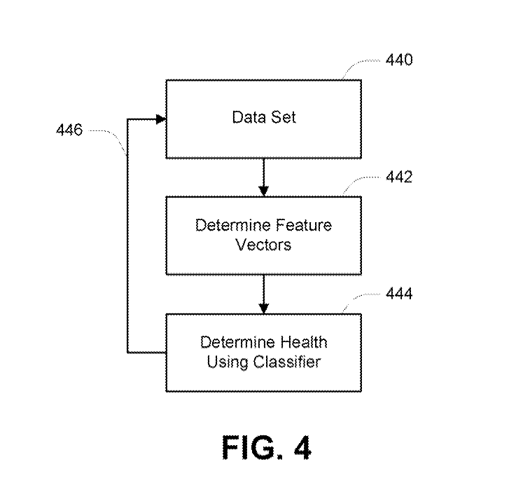

FIG. 2 depicts the hierarchy in the use of multiple classifiers in accordance with an embodiment of the disclosure. As shown in the example of FIG. 2, one or more classifiers addressing portions of a project, e.g., schedule health classifier 220, issue health classifier 222 and cost health classifier 224, provide inputs to the project health classifier 226. The one or more classifiers 220/222/224 receive input from one or more data sets, such as described with reference to FIG. 4, and provide output indicative of a health of some portion of each project, in this example schedule health, issue health and cost health. The data sets may be of a single database, such as a PPM database, or each data set might be separately maintained. In addition to receiving inputs from the one or more classifiers 220/222/224, the project health classifier 226 may further receive input from a data set, such as described with reference to FIG. 4. The project health classifier 226 provides output indicative of the overall health of one or more projects. In some embodiments, the one or more classifiers 220/222/224 may be eliminated such that a single classifier 226 is used to generate the output indicative of the overall health of the one or more projects.

Where health of one or more sets of projects, is of interest, each set containing one or more projects, a portfolio classifier 228 may be added. The portfolio classifier 228 receives the output of the project health classifier 226 as input. In addition to receiving input from the project health classifier 226, the portfolio health classifier 228 may further receive input from a data set, such as described with reference to FIG. 4. Because each classifier addresses a different aspect of health, each classifier would generally use different sets of features selected to address the different aspects. As such, they might have different data needs. However, while each classifier might use different data sets for training and use, each data set may reside in a single database, such as a PPM database.

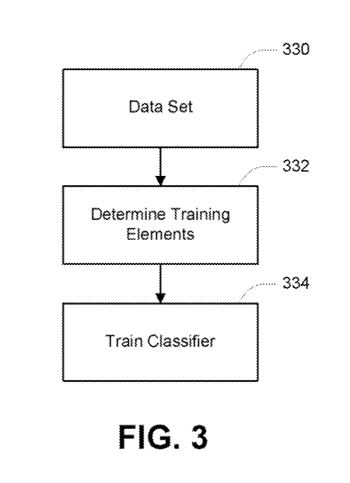

FIG. 3 depicts a flowchart of training of a classifier for use with embodiments of the disclosure. In general, to train a classifier, a data set 330 is generated or obtained. From the data set 330, training elements are determined at 332. The training elements for use in training a classifier are generally a set of training elements for each time interval of each project of the data set, where each training element is a feature vector for each selected feature (i.e., those features selected for a particular classifier as indicative of the health of that classifier's aspect of a project, whether that aspect is a portion of the project, the overall project, or a portfolio of projects) for a particular time interval and a particular project, and a classification deemed to be correct for that particular project at that particular time interval. More detail of the training elements is provided in subsequent examples. The determined training elements are then used to train the classifier at 334.

FIG. 4 depicts a flowchart of use of a classifier in accordance with embodiments of the disclosure. A data set 440 is generated or obtained. For one embodiment, the data set 440 includes at least a portion of a PPM database. The data set 440 may further include data external to a PPM database. From the data set 440, feature vectors are determined at 442 for one or more projects. More detail of determining feature vectors is provided in subsequent examples. The determined feature vectors are then used to determine an indication of health of the one or more projects using a trained classifier at 444. The data set 440 is then updated using the determined indications of health at 446, and the process may be repeated for a subsequent time interval of the one or more projects. It is noted that the determined indications of health may be manually overridden, i.e., modified, prior to updating the data set 440. Such modification may be performed prior to determining subsequent indications of health for subsequent time intervals, or it may be performed later, such as after completion of a project where the ultimate level of success or failure of that project can be used to guide a user to raise or lower a determined indication of health to more accurately reflect the ultimate level of success or failure.

The following examples will be used to provide additional detail as to how a classifier may be trained in accordance with embodiments described herein, and how such a trained classifier might be used to assess the health of a given aspect of a project. In a first example, one or more completed projects are split into a number of time intervals {t1, t2, . . . , tj}, for example, weeks. As noted above, the choice of time interval is configurable and at the discretion of a system administrator or other user. For each of the completed projects, p, a training element, e_{p,t}, (Eq. 1) is generated for each interval t that the project was active. The data for each training element is the feature vector F_{p,t} (Eq. 2) that represents selected features of the project, and the correct (i.e., deemed to be correct) classification, c_{p,t} of the metric of interest, e.g., project health:

e_{p,t}=(F_{p,t}, C_{p,t}) (Eq. 1)

The complete training set consists of such a training element for all intervals t and for all of the completed projects, p. This set is used to train a classifier.

For projects in progress, at any given interval t, the trained classifier is given the feature vector F_{p,t}, representing the selected features of the project, and provides a classification of the metric, c_{p,t}, e.g., project health.

In this embodiment, the feature vector, F_{p,t}, represents a snapshot of project p at time t, and includes all n relevant feature values for project p at time t:

F_{p,t}=f_{p,t}=(f_{1,p,t}, f_{2,p,t}, . . . , f_{n,p,t}) (Eq. 2)

In a second example, project history is utilized to extend the embodiment of the first example. In this manner, the data for each training element, e_{p,t} (Eq. 1), includes the history of the project up to and including time t. For projects in progress, the trained classifier is given the history of the project up to and including the current time, F_{p,t} (Eq. 3), and provides a classification of the desired metric, c_{p,t}, for the current time period, t. For example, compared to the first example, the feature vector for each time period, F_{p,t}, is changed to:

F_{p,t}=(f_{p,1}, f_{p,2}, . . . , f_{p,t}) (Eq. 3)
where f_{p,t} is as defined in Eq. 2.

In a third example, the data for each training element, e_{p,t} (Eq. 1), represents how individual project features are changing at time t, along with the correct (i.e., deemed to be correct) classification of the desired metric, c_{p,t}. The feature vector, F_{p,t} (Eq. 4), represents the set of deltas of features of the project between the current time, t, and a previous time, t−x. The time t−x may represent an immediately preceding time period, i.e., t−1, or some other preceding time period, i.e., t−2, t−3, t−4, etc. Thus, compared to the first example, the feature vector for each time period, F_{p,t}, is changed to:

F_{p,t}=((f_{1,p,t}−f_{1,p,t-x}), (f_{2,p,t}−f_{2,p,t-x}), . . . , (f_{n,p,t}−f_{n,p,t-x})) (Eq. 4)

For projects in progress, the trained classifier is given the deltas of the project features for that given time, F_{p,t} (Eq. 4), and provides a classification of the desired metric, c_{p,t}.

In a fourth example, a prediction of the metric for the next time period is provided. The data for each training element, e_{p,t} (Eq. 5), includes the history of the project up to time t−1, and the correct (i.e., deemed to be correct) classification of the desired metric (e.g., project health) in period t.

e_{p,t}=(F_{p,t-1}, c_{p,t}) (Eq. 5)

F_{p,t-1}=(f_{p,1}, f_{p,2}, . . . , f_{p,t-1}) (Eq. 6)
where f_{p,t} is as defined in Eq. 2.

For projects in progress, the trained classifier is given the history of the project up to the current time, and provides a projected classification of the desired metric, c_{p,t+1}, in the next, i.e., future, time period. Prediction in this manner can be used to complement the prior three examples, such as to provide an early warning of project health.

Although the preceding four examples were discussed in relation to project health, training and use of classifiers for other health aspects, such as schedule health, issue health and cost health (e.g., addressing portions of a project), and portfolio health (e.g., addressing sets of one or more projects) can be performed in a like manner, with features selected to address the specific health aspects. Furthermore, where more than one classifier is used, such as depicted in FIG. 2, each classifier might be trained in the same manner, or one or more of the classifiers might use a different method of training than one or more other of the classifiers. In a similar manner, different classifiers might also use different statistical tools, e.g., one classifier might be a statistical linear classifier while another classifier might be a quadratic classifier. FIG. 2 depicts the hierarchy in the use of multiple classifiers in accordance with an embodiment of the disclosure.

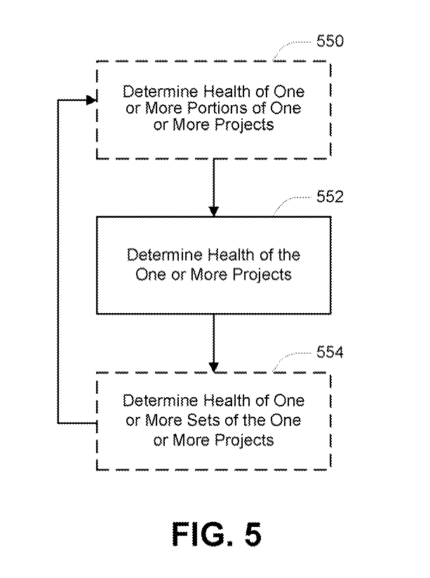

FIG. 5 depicts a flowchart of use of two or more classifiers in accordance with embodiments of the disclosure. FIG. 5 can be considered to be an expansion of the flowchart of FIG. 4. At 550, the health of one or more portions of one or more projects may be determined. For example, the health of portions of projects could be determined such as described with reference to FIG. 4. Portions of projects could include such items as costs, scheduling and issues. At 552, health of the one or more projects are determined. Where health of portions of projects are determined, the project health is determined using inputs from the various health determinations for those portions, and may further include inputs from a data set, such as a PPM database. However, it is noted that 550 is optional and project health may be determined using inputs from a data set as described with reference to FIG. 4. At 554, health of one or more sets of one or more projects may optionally be determined. Such a portfolio health determination may be beneficial in evaluating the overall performance of a project manager, for example. The process can then be repeated for subsequent time intervals.

Although specific embodiments have been illustrated and described herein it is manifestly intended that the scope of the claimed subject matter be limited only by the following claims and equivalents thereof.

What is claimed is:

1. A method for assessing health of a project, comprising:
determining vectors for a set of project features;
determining an indication of health of some aspect of the project using a classifier trained for the set of project features.

2. The method of claim 1, wherein determining an indication of health comprises determining an indication of health selected from the group consisting of a red/amber/green indication and a scaled indication.

3. The method of claim 1, wherein determining an indication of health of some aspect of the project comprises determining an indication of health of some aspect selected from the group consisting of issue health, schedule health, cost health, project health or health of a portfolio containing the project.

4. The method of claim 1, wherein determining vectors comprises determining vectors on a periodic basis.

5. The method of claim 1, wherein determining vectors comprises determining vectors as a snapshot of the project at a particular time interval.

6. The method of claim 1, wherein determining vectors comprises determining vectors as a history of the project up to and including a particular time interval.

7. The method of claim 1, wherein determining vectors comprises determining vectors as a set of deltas of the set of features between a particular time interval and a previous time interval.

8. The method of claim 7, wherein the previous time interval is an immediately preceding time interval.

9. A method of training a classifier for assessing project health, the method comprising:
determining a set of training elements for one or more projects of a data set, each training element comprising a feature vector for a particular project at a particular time interval and a health classification deemed to be correct for that particular project at that particular time interval; and
training the classifier using the set of training elements.

10. The method of claim 9, wherein determining a set of training elements comprises determining a set of training elements each comprising a feature vector for a given time interval and a health classification deemed to be correct for a time interval selected from the group consisting of the given time interval and a time interval immediately following the given time interval.

11. The method of claim 9, wherein determining a set of training elements comprises determining a set of training elements each comprising a feature vector representing a snapshot of a project at each particular time interval.

12. The method of claim 9, wherein determining a set of training elements comprises determining a set of training elements each comprising a feature vector representing a history of a project up to and including a given time interval.

13. The method of claim 9, wherein determining a set of training elements comprises determining a set of training elements each comprising a feature vector representing a set of deltas of a set of features between a given time interval and a previous time interval.

14. The method of claim 9, wherein determining a set of training elements comprises determining a set of training elements for one or more time intervals.

15. The method of claim 14, wherein determining a set of training elements for one or more time intervals comprises determining a set of training elements for one or more time intervals that are periodic.

16. The method of claim 15, wherein determining a set of training elements for one or more time intervals comprises using time intervals of the same period for each of the one or more projects.

17. The method of claim 9, wherein determining a set of training elements comprises determining a set of training elements specific to an industry, department or technology.

18. The method of claim 9, further comprising determining health of some aspect of another project in response to feature vectors of the another project, and updating the data set to include the determined health of some aspect of the another project.

19. The method of claim 18, further comprising manually overriding the determined health of some aspect of the another project in the data set, and re-training the classifier in response to the manually overriding.

20. A system, comprising:
a processor; and
one or more computer-usable media storing computer-readable instructions adapted to cause the processor to perform a method, the method comprising:
determining vectors for a set of project features;
determining an indication of health of some aspect of the project using a classifier trained for the set of project features.
